(19) United States
(12) Patent Application Publication
(10) Pub. No.: US 2006/0157970 A1
(43) Pub. Date: Jul. 20, 2006

(54) Form having a removable label

(76) Inventor: James L. Warmus, LaGrange, IL (US)

Correspondence Address: HANLEY, FLIGHT & ZIMMERMAN, LLC, 20 N. WACKER DRIVE, SUITE 4220, CHICAGO, IL, 60606, US

(21) Appl. No.: 11/038,000

(22) Filed: Jan. 18, 2005

(51) Int. Cl. B42D 15/00

(52) U.S. Cl. 283/81

(57) ABSTRACT

Methods and apparatus for a form having a removable label are disclosed. An example form includes a substrate having first and second faces with an opening therethrough, a liner attached to the first face of the substrate that covers only a portion of the opening, and a label removably disposed on the liner in the opening.

### FIELD OF THE DISCLOSURE

The present disclosure relates generally to forms and, more particularly, to a form having a removable label.

### BACKGROUND

In the manufacturing of business forms, it is often desirable to produce a form that holds a label that can be removed and adhered to another surface. For example, the Department of Motor Vehicles for a state may need a mailable form that holds a vehicle renewal sticker, which can be removed from the form and adhered to a recipient's license plate.

Typically, forms having a removable label are manufactured by adhering a release liner to a portion of the substrate of the form and adhering an adhesive backed removable label to the release liner. The problem with such a stacked construction is that the thickness of the form is increased by the thickness of the release liner, the adhesive(s) associated therewith, and the thickness of the removable label. Various problems occur with this design because a portion of the form is thicker than the remainder of the form. For example, the variation in thickness of the form could result in jams and other feeding, processing, and/or handling errors. Further, shipping and packaging time and costs increase because only a limited number of forms can be stacked before the stack becomes unstable and topples over. Also, the additional thickness increases the amount of packaging needed for a given number of forms. Still further, because the release liner and removable label are typically attached directly to a relatively thick and inflexible substrate, it is difficult to remove the label from the form.

More recently, U.S. Pat. No. 5,756,175 to Washburn attempted to solve some of the foregoing problems. Washburn describes a business form containing a removable label disposed within a window on the form. By die cutting a window in the form and locating the label in the window, the overall thickness of the form is reduced, which alleviates some of the packaging and shipping concerns noted above.

However, the form taught by Washburn requires the label to be adhered to a release liner to hold it in the window, the release liner to completely cover the window, and the entire perimeter of the release liner to be coated with adhesive to attach the release liner to the substrate. Placing the removable label on a liner having its entire perimeter adhered to the substrate limits significantly the flexibility of the liner, which makes it difficult to remove the label from the liner. Additionally, because the form taught by Washburn requires adhesive to extend entirely around the window, a relatively large amount of adhesive is needed.

### BRIEF DESCRIPTION OF THE DRAWINGS

FIG. 1 is a plain view of an example form having a removable label.

FIG. 2 is a cross-sectional view of the example form of FIG. 1 taken along the A1-A2 axis.

FIG. 3. is a cross-sectional view of the example form of FIG. 1 taken along the B1-B2 axis.

FIG. 4 is another example form.

FIG. 5 is a cross-sectional view of the example form of FIG. 4 taken along the C1-C2 axis.

FIG. 6 is a cross-sectional view of the example form of FIG. 4 taken along the D1-D2 axis.

FIG. 7 is a third example form.

FIG. 8 is a fourth example form.

FIG. 9 is a fifth example form.

FIG. 10 is a sixth example form.

### DETAILED DESCRIPTION

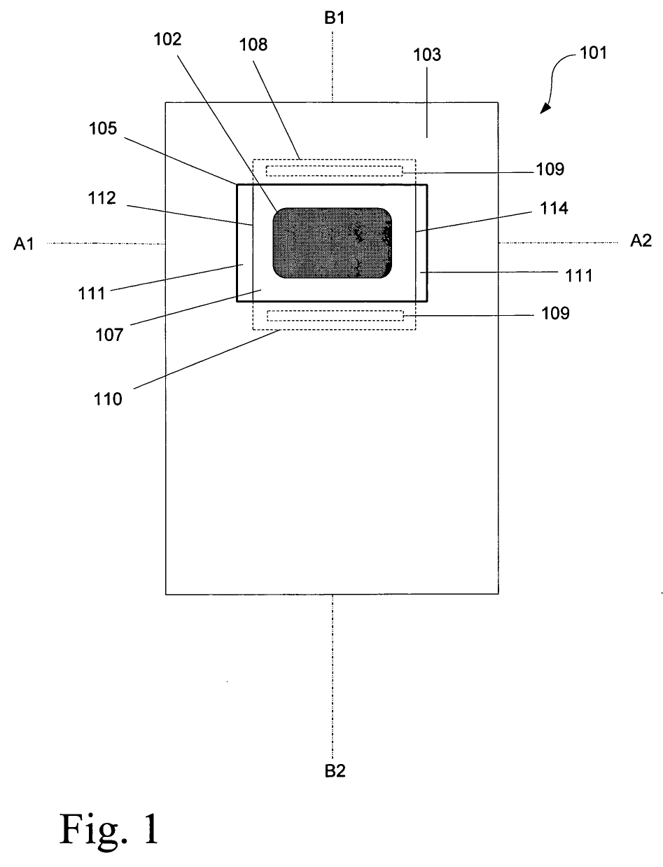

An example form 101 having a removable label 102 is illustrated in FIGS. 1-3. As shown in FIG. 1, the example form 101 has a substrate 103 with first and second sides or faces. An opening 105 is cut through the substrate 103. A liner 107 is attached to one face of the substrate 103. In particular, the liner 107 is attached so that it covers only a portion of the opening 105. In this example, two sides 108, 110 of the liner 107 extend beyond the inner edges of the opening 105.

The sides 108, 110 of the liner 107 are adhered to the substrate 103 with adhesive areas 109. Preferably the adhesive areas 109 use a pressure sensitive adhesive. However, any other adhesive could be used instead. Additionally, while the adhesive areas 109 are depicted as contiguous elongated or rectangular areas, the adhesive areas 109 could be implemented using a series of spaced dots or any other geometry or configuration sufficient to adhere the liner 107 to the substrate 103.

The sides 112, 114 of the liner 107 that are not adhered to the substrate 103 do not extend to the inner edges of the opening 105, thereby leaving gaps 111 between the liner 107 and the substrate 103 in the opening 105. The gaps 111 may be of various dimensions and numbers. For example, there may be one gap, or a plurality of gaps (as shown), or if a multi-piece liner is used (e.g., in a side-by-side configuration), there may be three or more gaps between the liner sections or pieces and the inner edges of the opening 105.

The gaps 111 impart substantial flexibility to liner 107 and, thus, enable the liner 107 and the label 102 to move (e.g., laterally) within the opening 105, which allows, for example, the liner 107 and the label 102 to center themselves in the opening. A further benefit to this construction is that less liner material and adhesive are needed, which reduces the cost of manufacture of the form 101.

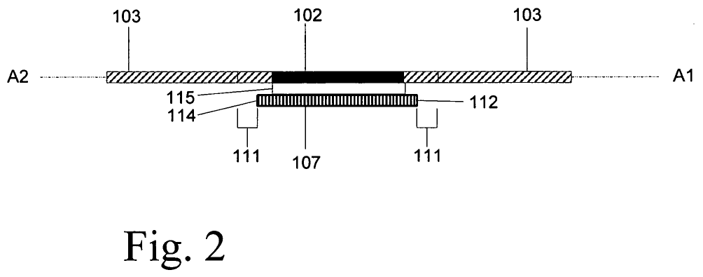

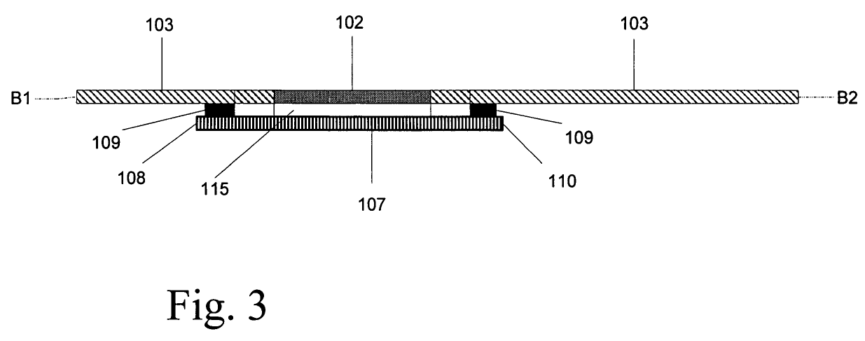

The removable label 102 is disposed on the liner 107 and within the opening 105 of the substrate 103. The label 102 is adhered to the liner 107 via a release coating 115, as best seen in FIGS. 2 and 3. The release coating 115 interposes between the label 102 and the liner 107 so that the label 102 and the liner 107 can be separated without damaging the label 102. In some examples, the liner 107 may be coated with the release coating 115. In other examples, the face of the label 102 that faces the liner 107 may be coated with the release coating 115. In still further examples, the release coating 115 may be disposed on a combination of the liner 107 and the label 102. Additionally, only a portion of the liner 107 and/or the label 102 may be coated with the release coating 115. The amount of release coating 115 used need only be an amount sufficient to adhere the removable label 113 to the liner 107.

In addition to the release coating 115, other adhesive(s) may be used to join the label 102 to the liner 107 so that the label 102 can be removed without damage. For example, a pressure-sensitive removable adhesive could be used instead of or in addition to the release coating 115.

In this example, the opening 105 and the removable label 102 have similar rectangular shapes. However, the opening 105 and the removable label 102 may have any other desired shapes, and, thus, their shapes may be substantially similar or substantially dissimilar to one another.

As described above, the liner 107 and the label 102 are moveable or displaceable (e.g., laterally and/or vertically) relative to the opening 105 in the substrate 103. There are several features of these embodiments that facilitate the removal of the removable label 113 from the liner 107. In particular, the liner 107 and the label 102 are laterally displaceable relative to the opening. Furthermore, the liner 107 is relatively flexible relative to the substrate 103. The flexibility of the liner 107 and the displaceablility of the liner 107 and the label 102 allow the recipient of the form 101 to easily remove the label 102 without damage. For example, the recipient can bend the liner 107 and peel back a portion (e.g., expose a free edge) of the label 102 so that the recipient can grasp the edge of the label 102 and remove the label 102 from the liner 107.

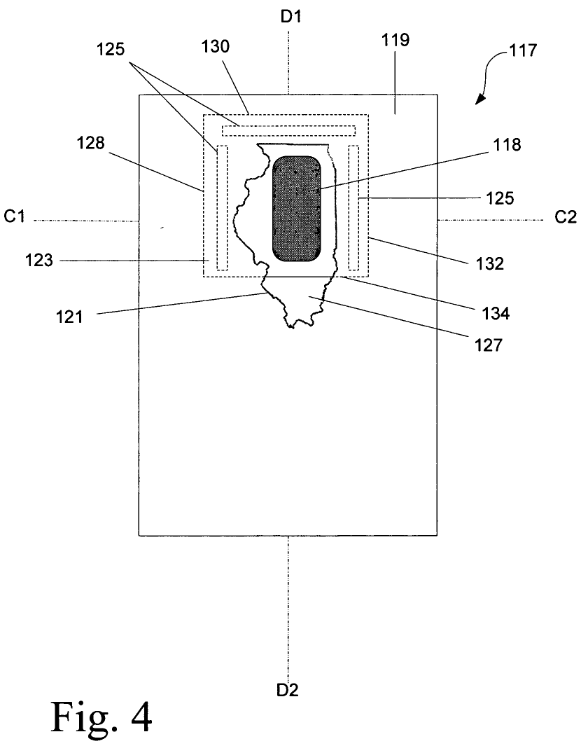

FIGS. 4-6 illustrate another example of a form 117 with a removable label 118. As shown in FIG. 4, the example form 117 has a substrate 119 with first and second sides or faces. An opening 121 is cut through the substrate 119. In this example, the opening 121 has an aesthetically interesting shape. In the prior example of FIGS. 1-3, the opening 105 had a rectangular shape. However, in this example, the opening 121 is shaped like the state of Illinois. As shown here, the opening 121 has a substantially dissimilar shape than the label 118. Both the label 118 and/or the opening 121 may be any shape. For example, the label and the opening may have a shape corresponding to a geographic region, a state, a country, a logo, etc.

The example in FIGS. 4-6 also provides for a liner 123 placed on one face of the substrate 119 over a portion of the opening 121. The liner 123 in this example is adhered to the substrate 119 on three sides 128, 130, 132 by three adhesive areas 125. As with the prior example of FIGS. 1-3, the adhesive areas 125 are depicted as contiguous elongated or rectangular areas. However, the adhesive areas 125 could be implemented using a series of spaced dots or any other geometry or configuration and amount sufficient to adhere the liner 123 to the substrate 119.

One side 134 of the liner 123 is not adhered to the substrate 119 and does not extend to the edge of the opening 121, thereby leaving a gap 127 between the liner 123 and the substrate 119 in the opening 121. The benefit and functionality of the gap 127 is discussed above in connection with the example of FIGS. 1-3. In other embodiments, more than one side, or portions of the perimeter of the liner 123 may not be adhered to the substrate 119, depending upon the shape of the opening 121.

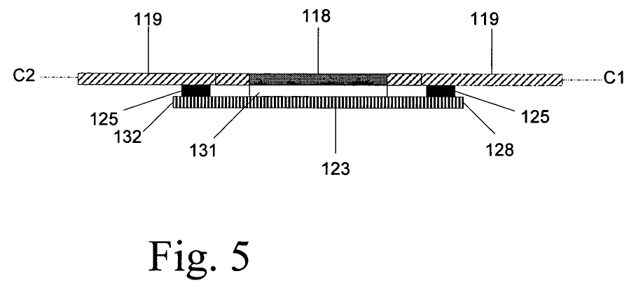

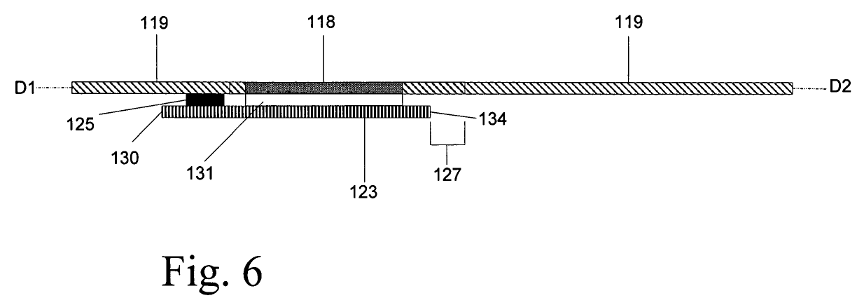

The removable label 118 is disposed on the liner 123 and within the opening 121 of the substrate 119. The label 118 is adhered to the liner 123 via a release coating 131, as best seen in FIGS. 5 and 6. The release coating 131 interposes between the label 118 and the liner 123 so that the label 118 and the liner 123 can be separated without damage to the label 118. As described above, in some examples, the liner 123 may be coated with the release coating 131. In other examples, the face of the label 118 that faces the liner 123 may be coated with the release coating 131. In still further examples, the release coating 131 may be disposed on a combination of the liner 123 and the label 118. Additionally, only a portion of the liner 123 and/or of the label 118 may be coated with the release coating 131. The amount of release coating 131 used need only be an amount sufficient to adhere the removable label 118 to the liner 123. In addition, as described above, other types of adhesive may be used to adhere the label 118 to the liner 123 other than the release coating 131.

Also as described above with the example of FIGS. 1-3, the liner 123 and the label 118 are displaceable within the opening 121 relative to the substrate 119. And the liner 123 is flexible with respect to the substrate 119. The functionality and benefits of these features is described above in the prior example.

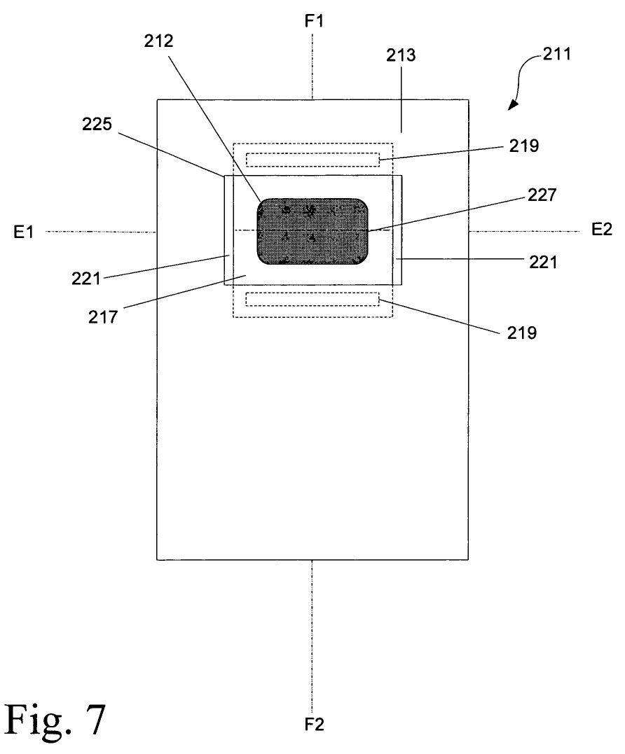

In yet another example, as seen in FIG. 7, a form 211, similar to the form 101 of FIGS. 1-3, may have a perforation 227 on a liner 217. The perforation 227 can be manipulated by the recipient of the form 211 to facilitate the removal of a label 212. For example, the recipient of the form 211 may tear the liner 217 along the perforation 227 to separate the liner 217 from the label 212. Once a portion of the label is separated from the liner 217, the recipient may grasp that portion of the label 212 and continue to separate the liner 217 from the label 212. The perforation 227 is shown across the middle of the liner 217 along the E1-E2 axis. However, the perforation 227 can be located anywhere on the liner 217, and there may be more than one perforation 227.

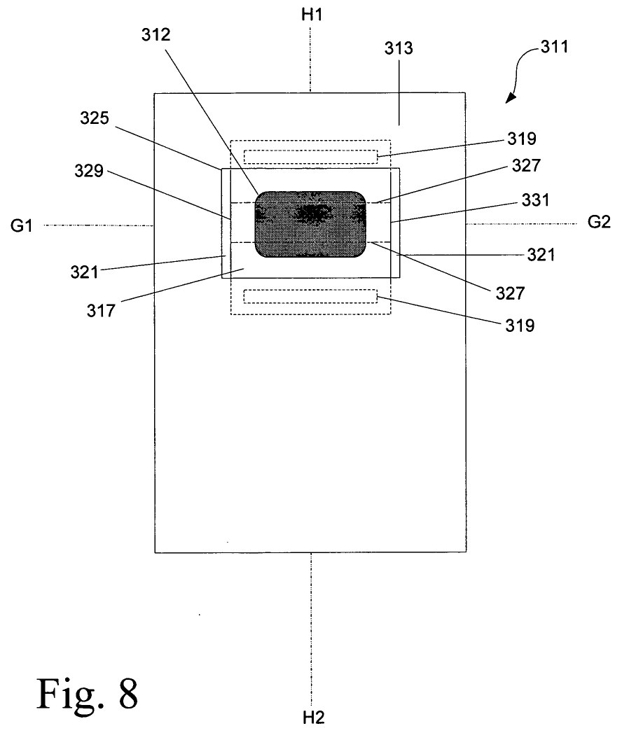

FIG. 8 shows an example form 311 that is similar to the form 211 of FIG. 7. However the example form 311 has two perforations 327 on a liner 317. The perforations 327 are generally parallel and extend across the liner 317 between gaps 321. The perforations 327 can be manipulated by the recipient of the form 311 to facilitate the removal of a label 312. For example, the recipient of the form 311 may tear the liner 317 along the perforations 327 to separate at least a portion of the liner 317 from the label 312. Once a portion of the label is separated from the liner 317, the recipient may grasp that portion of the label 312 and continue to separate the portion of liner 317 that is still attached to the label 312. Although the perforations 327 are shown parallel to the G1-G2 axis and perpendicular to sides 329, 331, the perforations 327 can be located anywhere on the liner 317.

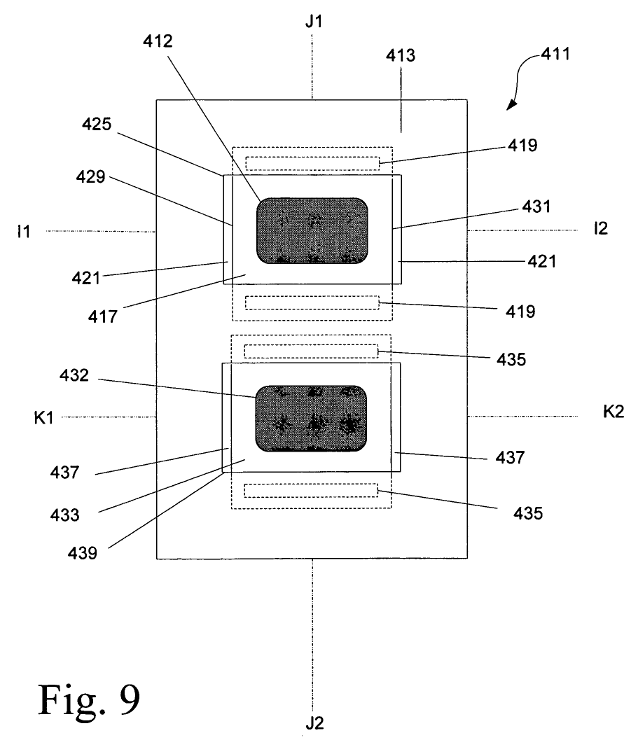

FIG. 9 shows an example form 411 that is similar to the form 101 of FIG. 1. However the example form 411 has two openings 425, 439. Each of the openings 425, 439 has a respective liner 417, 433 which is adhered to the substrate 413. The first liner 417 is adhered to the substrate by adhesive strips 419, and the second liner 433 is adhered by adhesive strips 435. The adhesive strips 419, 435 may be configured in any manner described above. Further, there is a first label 412 attached to the first liner 417 and a second label 432 attached to the second liner 433. The labels 412, 432 are removably attached in any manner described above. In addition, the openings 425, 439 and the labels 412, 432 may be of any shape, as described above, and the liners 417, 433 may be perforated as described in connection with the embodiment illustrated in FIG. 8. Furthermore, there may be several other openings in the substrate one or more of which may be associated with liners and/or labels.

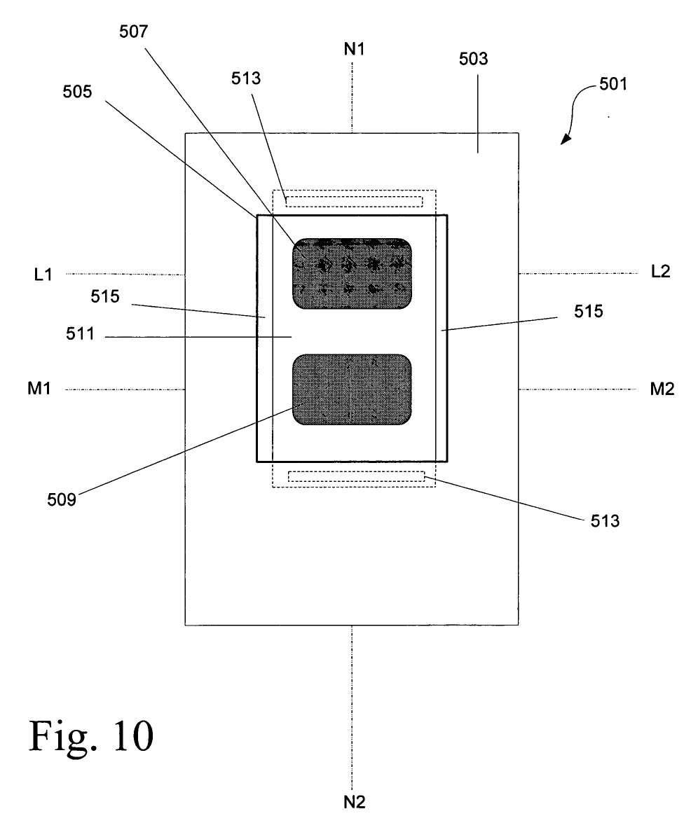

FIG. 10 shows yet another example form 501 that is similar to form 101 of FIG. 1. However, the form 501 has two labels 507, 509 on a liner 511 in an opening 505 of the substrate 503. The labels 507, 509 are attached to the liner 511, which is attached to the substrate 503 in manners described above. Furthermore, there may be other labels attached to the liner 511.

Many example forms with various shaped openings, number of openings, shaped labels, number of labels, perforations and number of perforations have been discussed. Any combination of any of these characteristics is contemplated by these examples and through this disclosure.

Although certain example methods and apparatus have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A form having a removable label, comprising:
a substrate having first and second faces and an opening therethrough;
a liner attached to the first face of the substrate to cover only a portion of the opening; and
a label removably disposed on the liner in the opening.

2. A form as defined in claim 1, wherein there is a plurality of labels disposed on the liner in the opening.

3. A form as defined in claim 1, wherein there is a plurality of openings in the substrate.

4. A form as defined in claim 1, wherein a portion of the liner covering the opening in the substrate has a release coating.

5. A form as defined in claim 1, wherein a portion of the removable label that faces the liner has a release coating.

6. A form as defined in claim 1, wherein the liner is not attached to and is spaced from at least a portion of an inner edge of the opening.

7. A form as defined in claim 1, wherein the shape of the opening corresponds to a geographic region, a state, a country or a logo.

8. A form as defined in claim 1, wherein the label and the opening have substantially similar shapes.

9. A form as defined in claim 1, wherein the liner is attached to the substrate via a pressure sensitive adhesive.

10. A form as defined in claim 1, wherein the liner and the label are configured so that the liner and the label are displaceable relative to the opening.

11. A form as defined in claim 1, wherein a portion of the liner covering the opening in the substrate has at least one perforation.

12. A method of constructing a form having a removable label, the method comprising:
creating an opening in a substrate of a form;
positioning a liner on a portion of one side of the substrate so that at least one portion of the opening is not covered by the liner; and
placing a removable label on the liner.

13. A method of constructing a form having a removable label as described in claim 12 further comprising placing a plurality of labels on the liner in the opening.

14. A method of constructing a form having a removable label as described in claim 12 further comprising creating a plurality of openings in the substrate.

15. A method of constructing a form having a removable label as described in claim 12 further comprising covering a portion of a side of the liner with a release coating.

16. A method of constructing a form having a removable label as described in claim 12 further comprising covering a portion of a side of a removable label with a release coating.

17. A method of constructing a form having a removable label as described in claim 12, wherein positioning the liner on the portion of one side of the substrate comprises positioning the liner so that the liner is not attached to and is spaced from at least a portion of an inner edge of the opening.

18. A method of constructing a form having a removable label as described in claim 12, wherein the opening has a shape corresponding to a geographic region, a state a country or a logo.

19. A method of constructing a form having a removable label as described in claim 12, wherein the liner and the label are configured so that the label is displaceable relative to the opening.

20. A method of constructing a form having a removable label as described in claim 12, wherein a portion of the liner covering the opening in the substrate has at least one perforation.

21. A form having a removable label, comprising:
a substrate having first and second faces and an opening therethrough, wherein the opening has a plurality of edges;
a liner attached to the first face of the substrate, wherein the liner is not attached to the substrate at one edge of the opening; and
a label removably disposed on the liner in the opening.

22. A form as defined in claim 21, wherein a portion of the liner has at least one perforation.
